(19) United States
(12) Patent Application Publication
(10) Pub. No.: US 2014/0051774 A1
(43) Pub. Date: Feb. 20, 2014

(54) METHOD AND DEVICE FOR PRODUCING COMPOSITION HAVING DISPERSED PHASE FINELY DISPERSED IN CONTINUOUS PHASE

(71) Applicant: Mitsuya Shimoda, Fukuoka-shi (JP)

(72) Inventor: Mitsuya Shimoda, Fukuoka-shi (JP)

(73) Assignee: KYUSHU UNIVERSITY, NATIONAL UNIVERSITY CORPORATION, Fukuoka-shi, Fukuoka (JP)

(21) Appl. No.: 14/005,487

(22) PCT Filed: Mar. 30, 2012
(86) PCT No.: PCT/JP2012/058520

§ 371 Date: Nov. 5, 2013

(30) Foreign Application Priority Data
Mar. 31, 2011 (JP) 2011-077111

(51) Int. Cl. B01F 3/08

(52) U.S. Cl. CPC B01F 3/0803; B01F 3/088
USPC 514/789; 106/316; 516/9; 430/113; 366/165.1; 426/602

(57) ABSTRACT

An object of the present invention is to provide a method for producing a composition having a disperse phase finely dispersed in a continuous phase with low polydispersity, the method which is excellent in production efficiency

This object is achieved by a method for producing a composition having a disperse phase finely dispersed in a continuous phase, the method comprising the steps of: (A) supplying a swirl flow of a continuous phase liquid into a cylinder having a circumferential surface partially or wholly composed of a porous membrane; (B1) jetting a disperse phase fluid through the porous membrane into the swirl flow to form a fluid column extending from a surface of the porous membrane into the cylinder; and (B2) by means of a shear force of the swirl flow, cutting off a part of the fluid column at a position with a distance of 2P to 10P in a radial direction from the surface of the porous membrane, where P is an average pore size of the porous membrane.

### TECHNICAL FIELD

The present invention relates to a method and device for producing a composition having a disperse phase finely dispersed in a continuous phase.

### BACKGROUND ART

There are known various compositions having a disperse phase finely dispersed in a continuous phase, including emulsions having a disperse phase liquid finely dispersed in a continuous phase liquid, and microbubble compositions having a disperse phase gas finely dispersed in a continuous phase liquid. Emulsions are widely used in foods, cosmetics, chemical products, and pharmaceutical products; thus, the particle size of disperse phase particles must be varied depending on the need.

One of emulsion production methods that have been proposed is a method in which a disperse phase liquid is directly injected into a continuous phase liquid through a porous membrane having uniform fine pores (hereinafter also referred to as “direct membrane emulsification”) (Patent Documents 1 and 2). Another is a method in which an emulsified oil and fat composition having an average particle size 1-20 times the pore size of a porous membrane is preliminarily prepared and then caused to pass through the porous membrane having a uniform pore size; whereby the composition is re-emulsified to give an average particle size 1-3 times the pore size of the porous membrane (hereinafter also referred to as “membrane emulsification method involving preliminary emulsification”) (Patent Document 3).

As the direct membrane emulsification method, there has been proposed a method in which a disperse phase liquid is pushed out into a flow of a continuous phase liquid through a porous membrane with a small pore size distribution like a Shirasu porous glass membrane to thereby produce fine droplets (hereinafter also referred to as “cross-flow membrane emulsification method”) (Non-patent Document 1). This method requires using a membrane that is easily wettable with a continuous phase liquid but less wettable with a disperse phase liquid. In such a cross-flow membrane emulsification method, the continuous phase liquid flowing in a cylindrical membrane along the cylindrical axis produces a shear force on the surface of the membrane. Also, the distortion of an extremely deformed disperse phase droplet formed in a pore outlet produces a cutting force strong enough to break up the part connecting the disperse phase liquid present in a pore and the disperse phase droplet (this part is hereinafter also referred to as “neck”). These shear and cutting forces release and disperse the disperse phase droplets into the continuous phase liquid.

In the cross-flow membrane emulsification method, a continuous phase liquid is caused to flow in parallel to a porous membrane and, thus, as the membrane permeation rate of the disperse phase liquid increases, the flow of the continuous phase liquid becomes farther from the surface of the membrane so that it becomes impossible for a sufficient shear force to be applied to disperse phase droplets present on the membrane surface. In turn, it becomes difficult to supply surfactant molecules dissolved in the continuous phase liquid onto the surface of the disperse phase droplets. Accordingly, in order to obtain an emulsion having a disperse phase with relatively uniform particle size, the membrane permeation rate of the disperse phase liquid has had to be set to an extremely low value of about 0.001-0.01 m³/m²h.

### CITATION LIST

### Patent Documents

Patent Document 1: Japanese Unexamined Patent Application Publication No. 2003-270849
Patent Document 2: Japanese Unexamined Patent Application Publication No. H02-95433
Patent Document 3: Japanese Patent No. 2768205

### Non-Patent Document

Non-patent Document 1: Journal of Membrane Science, Vol. 299 (2007), 190-199

### SUMMARY OF INVENTION

### Technical Problems

As mentioned above, there has been a problem where a method for producing a composition like an emulsion, which has a disperse phase finely dispersed in a continuous phase, is required to be improved in the production efficiency of the composition by increasing the supply rate of a disperse phase liquid, but this problem has not been solved.

In light of these circumstances, an object of the present invention is to provide a method for producing a composition having a disperse phase finely dispersed in a continuous phase with low polydispersity, the method which is excellent in production efficiency.

### Solution to Problems

As a result of intensive studies, the present inventors have found that the above-mentioned object can be achieved by supplying a continuous phase liquid in the form of a swirl flow and jetting a disperse phase fluid into the swirl flow through the pores of a porous membrane, and thus have completed the present invention. More specifically, this invention achieves said object by providing:

(1) a method for producing a composition having a disperse phase finely dispersed in a continuous phase, the method comprising the steps of: (A) supplying a swirl flow of a continuous phase liquid into a cylinder having a circumferential surface partially or wholly composed of a porous membrane; (B1) jetting a disperse phase fluid through the porous membrane into the swirl flow to form a fluid column extending from a surface of the porous membrane into the cylinder; and (B2) by means of a shear force of the swirl flow, cutting off a part of the fluid column at a position with a distance of 2P to 10P in a radial direction from the surface of the porous membrane, where P is an average pore size of the porous membrane; and

(2) a production device for a method for producing a composition having a disperse phase finely dispersed in a continuous phase, the production device comprising: a cylinder composed of a porous membrane and a non-porous membrane, the cylinder being provided on a circumferential surface in the vicinity of one end thereof with an inlet for a continuous phase liquid and also provided in a cross section of the other end thereof with an outlet for the composition having the disperse phase finely dispersed in the continuous phase; a disperse phase fluid storage portion provided on an outer whole periphery of the circumferential surface of the cylinder; a jetting means for causing the disperse phase fluid from the disperse phase fluid storage portion to permeate the porous membrane and to jet into the cylinder, thereby forming a fluid column extending from a surface of the porous membrane into the cylinder; and an introducing pipe connected to the inlet and extending approximately vertically to an axis of the cylinder and in a tangential direction to the cylinder, such that the continuous phase liquid can be caused to flow approximately vertically to the axis of the cylinder and from the tangential direction to the inner wall surface of the cylinder to produce a swirl flow and that, by means of a shear force of the swirl flow, a part of the fluid column can be cut off at a position with a distance of 2P to 10P in a radial direction from the surface of the porous membrane, where P is an average pore size of the porous membrane, whereby a disperse phase particle can be produced.

### Advantageous Effects of Invention

The present invention can provide a method for producing a composition having a disperse phase finely dispersed in a continuous phase with low polydispersity, the method which is excellent in production efficiency.

### BRIEF DESCRIPTIONS OF DRAWINGS

FIG. 1 is a schematic diagram of a preferred device of the present invention.

FIG. 2 is a schematic diagram of another preferred device of the present invention.

FIG. 3 is a cross-sectional view of section Y-Y in FIG. 1 as viewed from the direction of arrows.

FIG. 4 is a schematic diagram illustrating the formation of a disperse phase particle.

FIG. 5 is a diagram illustrating the relationship between the membrane permeation rate and particle size of the disperse phase.

FIG. 6 is a diagram illustrating the relationship between the membrane permeation rate of the disperse phase and the forces acting on the disperse phase fluid.

### DESCRIPTION OF EMBODIMENTS

### 1. Method for Producing a Composition

The method of the present invention for producing a composition having a disperse phase finely dispersed in a continuous phase comprises the steps of: (A) supplying a swirl flow of a continuous phase liquid into a cylinder having a circumferential surface partially or wholly composed of a porous membrane; (B1) jetting a disperse phase fluid through the porous membrane into the swirl flow to form a fluid column extending from a surface of the porous membrane into the cylinder; and (B2) by means of a shear force of the swirl flow, cutting off a part of the fluid column at a position with a distance of 2P to 10P in a radial direction from the surface of the porous membrane, where P is an average pore size of the porous membrane.

The composition having a disperse phase finely dispersed in a continuous phase means a composition having disperse phase particles with an average particle size not greater than 50 μm dispersed in a continuous phase (hereinafter also referred simply to as “composition”). The particle size is determined by the laser diffraction/scattering method, and the average particle size is defined as the median particle size (d₅₀) corresponding to the value at which the cumulative volume percentage of particles is 50%. The composition of this invention is characterized by low polydispersity. For the purpose of this invention, the term “low polydispersity” means that the polydispersity represented by the following equation (1) (hereinafter also referred to as “span”) is in the range of 0.2 to 1.5:

Span=(d₉₀−d₁₀)/d₅₀ (1)

where:

d₁₀: the particle size at 10% in the cumulative distribution of liquid droplets (disperse phase particles),

d₉₀: the particle size at 90% in the cumulative distribution of liquid droplets (disperse phase particles),

d₅₀: the particle size at 50% in the cumulative distribution of liquid droplets (disperse phase particles).

Examples of the composition of the present invention include emulsions having a disperse phase liquid finely dispersed in a continuous phase liquid, and microbubble compositions having a disperse phase gas finely dispersed in a continuous phase liquid.

(1) Step A

1) Continuous Phase Liquid

At this step, a swirl flow of a continuous phase liquid is supplied to a cylinder having a circumferential surface partially or wholly composed of a porous membrane. The continuous phase liquid means a liquid that is to serve as a continuous phase. In the present invention, a known continuous phase liquid such as an aqueous liquid or an oily liquid can be used. The aqueous liquid means a liquid based on water. The oily liquid means a liquid based on an organic compound. The composition of this invention cannot be obtained when the continuous phase liquid and the disperse phase fluid are highly compatible with each other; thus, the continuous phase liquid is selected in consideration of the compatibility with the disperse phase fluid to be used.

It is sufficient that the continuous phase liquid be liquid when it is supplied to a cylinder. Thus, for example, a substance that is solid at room temperature but becomes liquid by being heated can also be used as the continuous phase liquid. Alternatively, a supercooled liquid that is liquid at room temperature but solidifies with time can also be used. In consideration of workability, this step is preferably taken at room temperature (20-30° C.), so the continuous phase liquid is preferably liquid at room temperature. Such a liquid is exemplified by an inorganic substance and an organic substance. Examples of the inorganic substance include water, and examples of the organic substance include various edible oils, petroleum fuel oils, chain hydrocarbons having about 20 or less carbon atoms, and aromatic hydrocarbons having about 20 or less carbon atoms.

The continuous phase liquid may contain additives such as a surfactant, an electrolyte, and a viscosity modifier. As the surfactant, a known surfactant can be used, and an anionic or nonionic surfactant is preferred. Since such a surfactant has no positive charge, it has an advantage in that, when a porous membrane made of glass is used, said surfactant and anions arising from silanol groups are not electrostatically attracted to each other, so that the surfactant does not experience a decrease in its activity as a surfactant. Examples of the anionic surfactant include carboxylates, sulfonates, and sulfuric acid ester salts. Examples of the nonionic surfactant include polyglycerol fatty acid esters, sucrose fatty acid esters, polyoxyethylene alkyl ethers, and polyoxyethylene alkylphenyl ethers. The surfactant can be added in a commonly used amount, but an amount of 0.01-5 mass % in the continuous phase liquid is preferred and an amount of 0.02-2 mass % is more preferred.

Examples of the electrolyte include sodium chloride and potassium chloride. Addition of the electrolyte to the continuous phase liquid stimulates the formation on a porous membrane surface of an electric double layer where positively and negatively charged particles are paired with each other and arranged in a laminar fashion, thereby preventing the porous membrane from getting wet with the disperse phase fluid. In turn, the activity of the surfactant can be improved to reduce the size of disperse phase particles to be produced at the next step. The amount of the electrolyte to be added is preferably in the range of 0.5-5.0 mass % in the continuous phase liquid.

As the viscosity modifier, a known viscosity modifier can be used, and preferred examples include hydrophilic polymeric compounds such as polyvinyl alcohols, pectins, and gelatins.

2) Cylinder

The cylinder means a cylindrical member that is hollow in its interior. The cylinder of the present invention has a circumferential surface partially or wholly composed of a porous membrane. The porous membrane means a membrane having a large number of fine through-holes. As such a membrane, a known porous membrane made of glass, ceramic, nickel, or the like can be used. In the present invention, a porous membrane made of glass is preferred, and a porous membrane made of Shirasu porous glass (hereinafter also referred to as “SPG membrane”) as disclosed in Non-patent Document 1 is more preferred. The average pore size P of the porous membrane can be appropriately selected depending on the desired disperse phase particle size, but in order to obtain an industrially preferred disperse phase particle size, the average pore size is preferably in the range of 0.5 to 10 μm and more preferably in the range of 1 to 5 μm. The porosity and average pore size of the porous membrane can be measured by mercury intrusion porosimetry (using an automated porosimeter). The porous membrane is not uniform in pore size and thus has a span. The span is determined according to the equation (1) mentioned above and is preferably not greater than 0.6 in the present invention.

The phrase “having a circumferential surface partially or wholly composed of a porous membrane” means that that part of the circumferential surface which is used to supply a disperse phase fluid is composed of a porous membrane, whereas the other part may be composed of a non-porous material. As will be mentioned later, in the present invention, the continuous phase liquid is preferably introduced from the circumferential surface of the cylinder and approximately vertically to the axis of the cylinder. In such a case, it is preferred that the circumferential surface of the cylinder should be wholly composed of a porous membrane and that part of the porous membrane which is in the vicinity of the place where the continuous phase liquid is to be introduced should be subjected to such a treatment that prevents the continuous phase liquid from leaking out of the cylinder. To be specific, the continuous phase liquid can be prevented from leaking out of the cylinder by applying a coating to the inner wall surface or outer wall of said part of the porous membrane. Alternatively, a cylinder having a circumferential surface composed of some other material may be connected to an end of a cylinder having a circumferential surface composed of a porous membrane to provide an integral cylinder, and the integral cylinder may be used as the cylinder of the present invention.

Further, in the present invention, the area of the porous portion of the cylinder is preferably smaller than that of a disperse phase fluid storage portion provided over the outer periphery of the cylinder. As will be mentioned in detail later, this is because adopting such a structure improves the membrane permeation rate of the disperse phase fluid.

The shape and size of the cylinder of the present invention are not particularly limited, and it is preferred that the cross-sectional area thereof should be fixed longitudinally and that the inner diameter thereof should be in the range of 5 to 100 mm. If the inner diameter is lower than 5 mm, it may be difficult, in some cases, to generate a swirl flow in the cylinder. If the inner diameter is higher than 100 mm, an excessive supply of the continuous phase may be required to generate a swirl flow. The length of the cylinder is preferably 2-50 times the inner diameter thereof. If the length is less than twice the inner diameter, the effectively usable membrane area (hereinafter also referred to as “effective membrane area”) will be smaller so that the mixing efficiency can decrease. In contrast, if the length is more than 50 times the inner diameter, the swirling velocity in the cylinder may be non-uniform. If the swirling velocity is not uniform, the particles dispersed in the composition are more likely to be non-uniform in size.

3) Swirl Flow

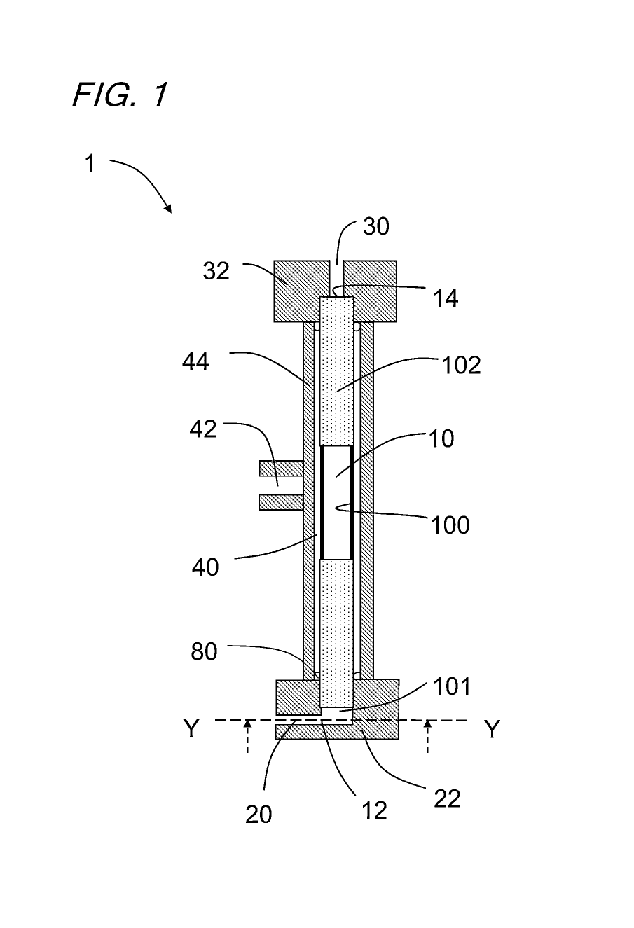

The swirl flow means a flow that combines a flow along the axis of the cylinder with a flow along the circumferential surface. The swirl flow can be generated by a known technique. For example, a screw propeller is provided on an end of the cylinder and, while the screw propeller is rotated, the continuous phase liquid is supplied to the cylinder, whereby a swirl flow of the continuous phase liquid can be fed into the cylinder. In the present invention, however, the swirl flow is preferably fed as shown in FIG. 1. Generating a swirl flow in such a manner provides advantages such as ease of controlling a swirling velocity. The following describes this mode with reference to a figure.

FIG. 1 shows a schema of a preferred device of the present invention. In FIG. 1, 1 represents a production device of the present invention, and 10 represents a cylinder. In the cylinder 10, 100 represents a porous membrane portion having a circumferential surface composed of a porous membrane (this numeral may represent the porous membrane itself), 101 represents a non-porous membrane portion having a circumferential surface composed of some other member, 102 represents a non-porous membrane portion formed by covering a porous portion of the cylinder 10 with a non-porous member such as a polymer film. 12 represents an inlet for the continuous phase liquid, 14 represents an outlet for the composition, 20 represents an introducing pipe, 22 represents a member constituting the introducing pipe, 30 represents a discharge pipe, 32 represents a member constituting the discharge pipe, 40 represents a disperse phase fluid storage portion, 42 represents an introducing pipe for the disperse phase fluid, and 44 represents a member constituting the disperse phase fluid storage portion. In FIG. 1, 80 represents a seal ring. FIG. 3 is a cross-sectional view of section Y-Y in FIG. 1 as viewed from the direction of arrows. In FIG. 3, 16 represents an inner wall surface of the cylinder 10.

As shown in FIG. 1, the cylinder 10 has the inlet 12 being provided on a circumferential surface in the vicinity of one end thereof (i.e., a circumferential surface of the non-porous membrane portion 101), and the inlet 12 has connected thereto the introducing pipe 20 which extends approximately vertically to the axis of the cylinder. The term “vicinity” as used herein refers to the range from the origin to 0.1, with the origin being an end of the cylinder which is assumed to have a total length of 1. The term “approximately vertically” means that the angle formed by the axes of the introducing pipe 20 and the cylinder 10 is in the range of 85 to 95°, preferably in the range of 88 to 92°, and more preferably 90° (vertical). As shown in FIG. 3, the introducing pipe 20 extends in the tangential direction to the cylinder 10 so that the continuous phase liquid can be introduced from the tangential direction to the inner wall surface 16 of the cylinder 10. In other words, part of the inner wall surface of the introducing pipe 20 is located on the same plane as the tangent to the inner wall surface 16 of the cylinder 10. The flow of the continuous phase liquid runs along the inner wall surface 16 in the circumferential direction of the cylinder 10 and, at the same time, is pushed out toward the other end of the cylinder 10, so that a swirl flow is produced.

In the present invention, the swirl flow velocity in the circumferential direction (hereinafter also referred to as “swirling velocity”) and that in the axial direction of the cylinder (hereinafter also referred to as “axial velocity”; and the swirling and axial velocities are also collectively referred to simply as “swirl flow velocity”) are preferably controlled according to the value obtained by dividing the flow rate of the continuous phase liquid running through the introducing pipe 20 by the inner-diameter cross-sectional area of the introducing pipe 20, i.e., according to the inlet linear velocity. The inlet linear velocity should be optimized in relation to the inner diameter of the cylinder, and is preferably in the range of about 1 to 40 m/s and more preferably in the range of 2 to 20 m/s. When the inlet linear velocity is within said range, a composition comprising relatively small disperse phase particles with low polydispersity can be produced effectively. The cross section of the introducing pipe 20 can be of any shape such as a rectangular shape or a circular shape, and the circular shape is preferred because this shape is easy to produce and makes it easy to obtain a uniform flow of the continuous phase liquid in the introducing pipe 20.

In the present invention, it is preferred that the thicknesses of the introducing pipe 20 and the cylinder 10 should have a specific relationship, since a swirl flow can then be effectively produced in the cylinder 10. The thicknesses of the cylinder 10 and the introducing pipe 20 preferably have such a relationship that, when the inner-diameter cross-sectional area of the cylinder 10 is denoted as S1 and that of the introducing pipe 20 is denoted as S2, the area ratio S1/S2 is in the range of 4 to 64. The inner-diameter cross-sectional area refers to, for example, in the case of the cylinder 10, the cross-sectional area of the portion through which the continuous phase liquid flows, and specifically refers to the area of a circle whose diameter is defined by the inner diameter of the cylinder 10. It is also preferred that in a particular case where the cross sections of the cylinder 10 and the introducing pipe 20 are of circular shapes having inner diameters denoted as X1 and X2, respectively, the inner diameter ratio X1/X2 should be in the range of 2 to 8.

Furthermore, the mode and axial velocity of the swirl flow in the cylinder 10 are affected by the size of the outlet 14 (Non-patent Document 2: Transactions of the Japan Society of Mechanical Engineers, Series B, Vol. 58, No. 550, p. 1668-1673 (1992)). If the cylinder 10 of the present invention has the outlet 14 as shown in FIG. 1, it is preferred that the cross section of the outlet 14 should be of a circular shape. If the outlet 14 is not of a circular shape, a non-uniform stress will be applied to the produced composition and disperse phase particles will, in some cases, be crushed. When the inner diameter of the outlet 14 having a circular shape is denoted as X0, the ratio of the inner diameter of the cylinder 10 (X1) to that of the outlet 14 (X0), i.e., ratio X1/X0, is preferably in the range of 1 to 5 and more preferably in the range of 1 to 3. X0 can be adjusted by varying the shape of the member 32 disposed at an end of the cylinder 10. The member 32 will be described later.

According to the present production method, the orientation for placing the device of the present invention is not limited, but the device is preferably placed such that the axis of the cylinder 10 is approximately vertical. This is because, when the swirl plane of the continuous phase liquid which swirls in the interior of the cylinder 10 is orthogonal to the direction of gravity, the swirling motion is less susceptible to acceleration of gravity. The term “approximately vertical” means that the angle formed by the horizontal line and the axis of the cylinder 10 is in the range of 85 to 95°, preferably in the range of 88 to 92°, and more preferably 90°.

(2) Steps B1 and B2

1) Disperse Phase Fluid

At this step, the disperse phase fluid is jetted through the porous membrane into the swirl flow. The jetting means injecting under high pressure, and as a result of the jetting process, liquid columns are formed which extend from the surface of the porous membrane into the continuous phase liquid in the cylinder. The liquid column means a columnar flow composed of the disperse phase fluid and having an end located on the surface of the porous membrane. The liquid column has a cross section commonly circular in shape. For the purpose of the present invention, the liquid columns include those deformed into a distorted shape (e.g., wavy shape) by the swirl flow.

The disperse phase fluid means a liquid that is to serve as a disperse phase, and examples include aqueous liquids, oily liquids and gases. The aqueous liquid is as described above for the continuous phase liquid. When an aqueous liquid is used as the disperse phase fluid, a W/O emulsion is obtained as the composition of the present invention. In order that the disperse phase fluid is jetted through the porous membrane into the continuous phase to thereby effectively form liquid columns which extend from the porous membrane surface into the cylinder, it is generally considered as preferable to avoid the porous membrane from getting wet with the disperse phase fluid. Therefore, when an aqueous liquid is used as the disperse phase, a hydrophobic porous membrane is preferred, and when an oily liquid or a gas is used as the disperse phase, a hydrophilic porous membrane is preferably used. In both cases, as an additional measures to prevent the porous membrane from getting wet with the disperse phase fluid, it is considered preferable that the disperse phase fluid should not contain a surfactant. However, even when the disperse phase fluid contains a surfactant, the present invention can produce the composition effectively. This mechanism is not limited but may presumably be explained as follows: since the swirl flow can apply a great shear force onto the membrane surface, the disperse phase fluid is cut into disperse phase particles quickly enough not to wet the membrane surface. When a surfactant is added to the disperse phase fluid, the composition can be obtained effectively even if the continuous phase liquid does not contain a surfactant. The addition of a surfactant to the disperse phase fluid offers other advantages such as significant reduction in the amount of surfactant used and reduction in the amount of the continuous phase liquid used. As the surfactant, those described above can be used.

The oily liquid refers to, as described above, a liquid based on an organic compound. When an oily liquid is used, an O/W emulsion is obtained as the composition of the present invention. Preferred oily liquids include edible oils and fatty acid esters, but the oily liquid can be selected as appropriate depending on its application. For example, emulsions produced using a fatty acid ester such as methyl laurate as the disperse phase are typically useful as cosmetic additives, food additives, or additives for coating materials.

When an oily liquid containing a polymerizable monomer is used, there can be produced an emulsion that has finely dispersed therein disperse phase particles containing a polymerizable monomer. This type of emulsion can be used as a starting material for suspension polymerization. The polymerizable monomer means a compound having a polymerizable functional group. Preferred in the present invention is a radical-polymerizable monomer that has a radical-polymerizable functional group and which can easily undergo advanced polymerization upon heating. Examples of this compound include: styrenic compounds such as styrene, α-methylstyrene, halogenated styrene, vinyltoluene, 4-sulfonamide styrene, and 4-styrene sulfonic acid; and acrylic esters or methacrylic esters such as methyl (meth)acrylate, ethyl (meth)acrylate, propyl (meth)acrylate, n-butyl (meth)acrylate, isobutyl (meth)acrylate, octyl (meth)acrylate, dodecyl (meth)acrylate, lauryl (meth)acrylate. In addition to these polymerizable monomers, a polymerizable monomer having a plurality of polymerizable functional groups per molecule, as exemplified by divinylbenzene, may also be used for the purpose of introducing a crosslinked structure into the resulting polymer.

When a polymerizable monomer is used as the oily liquid, it is preferred that the oily liquid should contain a known radical polymerization initiator. In addition, the oily liquid may contain a known coloring agent such as an organic dye, an organic pigment, an inorganic dye, or an inorganic pigment. The coloring agent is preferably a nanometer-sized particulate dispersion.

The emulsion of the present invention comprising a polymerizable monomer as a disperse phase provides polymer particles with low polydispersity or, in other words, fine monodispersed polymer particles. Such polymer particles are useful as spacers for liquid crystal display panels, fillers for liquid chromatography separation columns, cosmetic materials, and toner materials. In particular, the composition of this invention comprising a polymerizable monomer as a disperse phase is preferred in the field of toners where polymer particles with extremely low polydispersity are needed for increasing printing resolution.

When the disperse phase fluid is a gas, a microbubble composition having fine bubbles dispersed in the continuous phase is obtained as the composition of the present invention. In this case, the continuous phase can be an aqueous liquid or an oily liquid. Examples of the gas include air, oxygen, nitrogen, noble gas, carbon dioxide and ozone. When air or nitrogen is used as the gas, a whipped composition useful for producing aerated food products is obtained. When carbon dioxide is used as the gas, a microbubble composition useful for producing carbonated drinks is obtained. Finely dispersing an ozone-containing gas in water serving as the continuous phase is preferable both for producing ozone water and as a means for sterilizing water. In addition, cleaning and sterilization using this type of water can be important applications.

2) Jetting Method

The disperse phase fluid is jetted into the continuous phase liquid through the porous membrane. The method for jetting is not particularly limited. However, it is preferred that, as shown in FIG. 1, the member 44 should be disposed around the outer periphery of the cylinder 10 to create the disperse phase fluid storage portion 40, and the disperse phase fluid should be supplied to the storage portion 40 using a flow rate variable pump (not shown) generating only a few pulsating flows to jet the disperse phase fluid into the continuous phase liquid under high pressure and at high velocity. Thereupon, disperse phase fluid columns are formed in the continuous phase liquid 50 in the cylinder 10, and each of the fluid columns is partially cut off at a position with a specified distance from the inner wall of the porous membrane 100 to form disperse phase particles. This mechanism is not limited but may be explained as follows.

FIG. 4 is a schematic diagram for illustrating this mechanism. In FIG. 4, 100 represents a porous membrane, 60 represents a disperse phase fluid column, and L represents a vertical distance between the point at which to cut the disperse phase fluid column 60 and the inner surface of the porous membrane 100.

In general, when the disperse phase fluid is pushed out of the pores of the porous membrane 100, the disperse phase fluid is acted on by a force that retains the disperse phase fluid on the porous membrane surface and forces that release the disperse phase fluid from the porous membrane surface. The details are as described below. For the sake of simplifying description, the following description is made on the assumption that the disperse phase fluid is a disperse phase liquid.

(a) Droplet-Retaining Force (F_{interface})

F_{interface} is a force holding a disperse phase droplet in a pore opening and is proportional to the interfacial tension. The disperse phase droplet is connected through a neck to a disperse phase liquid present in a pore. The neck refers to a part that connects a disperse phase droplet present in a pore opening and a disperse phase liquid present in the pore. F_{interface} is defined by the following equation:

F_{interface}=γD₀

where γ: interfacial tension, D₀: pore size.

The interfacial tension γ is generally considered to be in the range of 10-30 mN/m, and is specified as 20 mN/m in the present invention (refer to Non-patent Document 3: Chemical Engineering and Design, Vol. 88, (2010), 229-238).

(b) Droplet-Releasing Forces: Inertial Force (Fᵢₙₑᵣₜᵢₐₗ), shear force (Fₛₕₑₐᵣ), Cutting Force (F_{distortion})

The inertial force Fᵢₙₑᵣₜᵢₐₗ is an inertial force generated when a disperse phase liquid is pushed out of a pore, and is defined by the following equation:

Fᵢₙₑᵣₜᵢₐₗ=ρQ²/D₀²

where Q: volumetric flow rate of a disperse phase liquid in a pore, ρ: disperse phase density.

The shear force Fₛₕₑₐᵣ is a shear force acted on a disperse phase liquid present on a porous membrane due to the velocity gradient on membrane surface of a continuous phase liquid swirling at high velocity, and is defined by the following equation:

Fₛₕₑₐᵣ=μdv/dzD₀²

where dv/dz: velocity gradient of a continuous phase liquid on a membrane surface, μ: coefficient of viscosity of a continuous phase liquid.

The cutting force F_{distortion} is a force for cutting off a disperse phase droplet, which is generated due to the deformation of the droplet. Since a porous membrane generally has extremely deformed, non-circular pore openings, droplets present in the openings deform as they are inflated and expanded. Originally, the surface area of a droplet is minimum when the droplet is spherical in shape, and increases as it deviates further from sphericity. Thus, when a droplet so deforms that it deviates from sphericity, excess surface energy accumulates on the droplet. F_{distortion} is generated by the excess energy (refer to Non-patent Document 4: Langmuir, Vol. 17, (2001), p. 5562-5566).

(c) Parameters

Based on the above-defined forces, the dimensionless parameters, i.e., Weber number We and capillary number Ca, are defined.

The Weber number We is defined as inertial force Fᵢₙₑᵣₜᵢₐₗ divided by interfacial tension γ. More specifically, the Weber number is represented by the following equation:

We=ρQ²/D₀³γ=ρπ²v²D₀/16γ

where ρ: density of a disperse phase liquid, D₀: pore size, v: linear velocity of a disperse phase in a pore.

The capillary number Ca is defined as shear force divided by interfacial tension.

If the Weber number and the capillary number are both small, in other words, if the inertial force and the shear force are small and the interfacial tension is large, a disperse phase liquid will be retained on a membrane surface, whereupon droplets will be formed on the porous membrane surface and will be released into a continuous phase liquid.

On the other hand, if the Weber number is large, in other words, if the inertial force is large, the force releasing the disperse phase liquid will be strong. Then, the disperse phase liquid will be vigorously introduced into the continuous phase liquid, whereupon no droplet will be formed on the porous membrane surface but liquid columns will instead be formed. In addition, if the capillary number is large, the shear force will be large and, thus, liquid columns will be cut by this shear force to form disperse phase particles. It is conventionally believed that capillary numbers of Ca>1 are difficult to obtain; according to the cross-flow method in which a continuous phase liquid is flowed in parallel to a porous membrane, only a capillary number of about 0.01 can be obtained at the maximum (refer to Non-patent Document 5: Chemical Engineering Research and Design, Vol. 88 (2010), p. 229-238). However, when the continuous phase liquid is supplied as a swirl flow as in the present invention, a capillary number of 0.1 to 1.0 can be obtained.

Therefore, it is considered that in the present invention, disperse phase liquid columns are formed in a swirl flow of the continuous phase by increasing the Weber number to some extent. Furthermore, the disperse phase liquid present on a membrane surface is given additional forces by the swirl flow: i.e., a force dragging the disperse phase liquid in the downstream direction and a force directing it toward the center of the swirl flow (centripetal force). This centripetal force is also considered to promote the formation of liquid columns.

Next, the liquid columns are cut by increasing the capillary number, in other words, by applying a strong shear force. Since the swirl flow is also superior in stirring efficiency, it makes contributions not only to quickly supplying a surfactant contained in the continuous phase to the disperse phase liquid columns to promote the cutting of the columns but also to preventing the fusion of the produced droplets. A liquid column is cut at a position with a specified distance (L) in the radial direction from the surface of the porous membrane 100, mainly by means of the shear force of the swirl flow. L is approximately in the range of 2P to 10P, where P is an average pore size of the porous membrane. Non-patent Document 6 (Physical Review Letters, Vol. 102, p. 194501-1-194501-4 (2009)) reports that in a case where a continuous phase is caused to flow parallelly on a plate with a single pore size, the position L at which to cut the formed liquid column is located at a position with a distance of about 2P to 10P (where P is a pore size) vertically from the membrane. The test results reported in Non-patent Document 6 are different from those of the present invention since they were obtained by supplying the continuous phase not as a swirl flow but as a parallel flow (cross flow), they. However, in the extreme vicinity of the membrane surface, the swirl flow is attenuated in turbulence to exhibit the property of a viscous bottom laminar flow having a linear velocity distribution; accordingly, it can be estimated from the results of Non-patent Document 6 that the value of L in the present invention is also approximately in the range of 2P to 10P.

On the basis of the above-described mechanism, the present invention can produce a composition having a disperse phase finely dispersed in a continuous phase with low polydispersity at high production efficiency.

In the present invention, it is preferred that the Weber number should be 0.3 or greater and the capillary number be 0.4 or greater. The Weber number is defined as We=ρQ²/D₀3γ and is proportional to the square of Q (volumetric flow rate of a disperse phase liquid in a pore). Thus, the Weber number can be increased typically by raising the supply rate of the disperse phase liquid. The above-mentioned equation is converted to the following equation: We=ρπ²v²D₀/16γ, wherein the Weber number is proportional to D₀ (pore size). Thus, the Weber number can be increased typically by expanding the pore size. In this invention, it is preferred that as shown in FIG. 1, the supply rate of the disperse phase liquid should be increased by particularly covering part of the cylinder 10 with a non-porous body such as a polymer film to reduce the area of the porous portion 100.

In this particular case, it is preferred for the present invention that the membrane permeation rate should be 24 m³/m²h or higher under normal conditions (0° C., 1 atm.). This rate is far higher than that of the conventional cross-flow method, but the present invention can produce a composition comprising disperse phase particles with small particle size and having low polydispersity even when this membrane permeation rate is increased. In a particular case where the disperse phase fluid is liquid, the membrane permeation rate is more preferably set to lie within the range of 24 to 60 (m³/m²h). The temperature at which to supply the disperse phase fluid is not particularly limited, and a room temperature (20-30° C.) is preferred as described above.

The capillary number is proportional to the shear force, in other words, dv/dz (velocity gradient of a continuous phase liquid on a membrane surface). Thus, this can be adjusted by the swirling velocity of the continuous phase liquid. In addition, it is considered that if a great number of disperse phase fluid columns are present on the membrane surface, resistance will be imparted to the swirl flow, causing an increase in the velocity gradient dv/dz. Thus, the capillary number can also be increased by raising the membrane permeation rate of the disperse phase fluid.

Further, it is considered that as the outlet velocity of the disperse phase fluid from the pores becomes higher, disperse phase fluid droplets become less deformed and that the degree of their deformation becomes almost zero when they depart from the porous membrane. Thus, it is considered that when disperse phase fluid columns are formed, the cutting force F_{distortion} is almost negligible in magnitude.

(3) Removal Step

The resulting composition of the present invention is removed from the outlet 14 provided at an end of the cylinder 10. As described above, the outlet is preferably provided in a cross section at an end of the cylinder 10 to have a circular shape with a specific inner diameter. The composition may also be removed through the discharge pipe 30 connected to the outlet 14.

2. Composition

(1) Disperse Phase Particle Size

The composition of the present invention is produced in the form of an O/W emulsion by using an aqueous liquid as a continuous phase liquid and an oily liquid as a disperse phase fluid, or in the form of a W/O emulsion by using an oily liquid as a continuous phase liquid and an aqueous liquid as a disperse phase fluid, or in the form of a microbubble composition by using an oily liquid or an aqueous liquid as a continuous phase liquid and a gas as a disperse phase fluid.

The particle size of the disperse phase particles is determined by the laser diffraction/scattering method, and the average particle size which is defined as the median particle size (d₅₀) corresponding to the value at which the cumulative volume percentage of particles is 50% is preferably in the range of 1 to 50 μm and more preferably in the range of 1 to 30 μm. The polydispersity defined by the equation (1) mentioned above (hereinafter also referred to as “span”) is preferably not greater than 1.5, and more preferably not greater than 1.0.

(2) Makeup and Applications

The component ratio of the composition of the present invention varies with the substances to be used and its applications. In the step for the production of an O/W or W/O emulsion which involves a single passage of a swirl flow through the cylinder, the volume ratio of disperse phase to continuous phase (disperse phase/continuous phase) is preferably in the range of about 0.005 to 0.5 and more preferably in the range of 0.1 to 0.5. Also, the ratio of disperse phase to continuous phase can be increased depending on the need by repeatedly circulating the produced emulsion as a continuous phase.

The ratio of gas to continuous phase in a microbubble composition varies with the gas to be used and the applications of the composition. The volume ratio of gas (normal conditions) to continuous phase (gas/continuous phase) is preferably in the range of 0.000001 to 50. For example, when a carbonated drink is produced as a microbubble composition, a volume ratio of about 5 is preferred. When ozone water is produced as a microbubble composition, a volume ratio of about 0.00001 is preferred.

As described above, the O/W and W/O emulsion compositions of the present invention are useful as food additives, additives for coating materials, spacers for liquid crystal display panels, fillers for liquid chromatography separation columns, cosmetic materials, toner materials, and the like. Also, as described above, the microbubble composition of this invention is useful for producing whipped compositions, carbonated drinks, or ozone water.

As will be described in the next section, when the composition of the present invention is used as a preliminary composition, a composition having a smaller disperse phase particle size can be produced.

3. Method for Producing a Fine-Grained Composition

In the present invention, the composition produced by the above-described method can also be used as a preliminary composition to thereby produce a composition comprising disperse phase particles with a smaller average particle size. For convenience' sake, said composition is also referred to as “fine-grained composition.” Specifically, this method comprises the steps of: (C) providing a preliminary composition having the disperse phase finely dispersed in the continuous phase according to the method described above; and (D) applying a shear force to the preliminary composition to obtain a composition having finely dispersed a disperse phase with a smaller average particle size than the disperse phase of the preliminary composition.

(1) Step C

This step is as described above.

(2) Step D

At this step, a shear force is applied to the preliminary composition to obtain a fine-grained composition. The method for applying a shear force is not particularly limited, and can be exemplified by a method in which the preliminary composition is passed through a porous membrane, or any other method that can be commonly used to obtain an emulsion. When the preliminary composition is an O/W or W/O emulsion, step D is also referred to as “re-emulsification step.”

In the method in which the preliminary composition is passed through a porous membrane, the porous membrane mentioned above is provided, the preliminary composition is supplied onto one surface of the membrane to pass said composition through the membrane, and a composition is recovered from the other surface. In the process, the preliminary composition passes through the interior of the porous membrane, in other words, through the pores having intricately tortuous, irregular cross sections, whereby disperse phase particles are divided under shear force to become more fine-grained. The porous membrane to be used in the process may be of a planar shape or may be of a cylindrical shape as described above.

When a cylinder composed of a porous membrane is used, this step may be performed while a continuous phase liquid is flowed into the cylinder. The continuous phase liquid may be supplied in the form of a swirl flow or a parallel flow, but the swirl flow is preferred because it allows disperse phase particles to be broken down into more fine-grained ones more efficiently. This swirl flow is preferably produced by the method described above in Section 1. In the process, the steps B1 and B2 described above may be performed with the preliminary composition instead of the disperse phase fluid being jetted into the swirl flow. The continuous phase liquid is not limited as long as it is a liquid compatible with the continuous phase liquid contained in the preliminary composition, and it is preferably the same as the continuous phase liquid in the preliminary composition.

The porous membrane to be used in the process may have the same pore size as the membrane used in step A, and a membrane with a smaller average pore size is preferably used because it allows dispersed particles to be smaller in size. Therefore, the ratio of the average pore size (A) of the membrane used at step A to the average pore size (D) of the membrane used at step D, i.e., ratio A/D, is preferably (40-1):1.

When any method that can be commonly used to obtain an emulsion is adopted at step D, the preliminary composition is preferably treated using a stirrer that is capable of applying a shear force as exemplified by a colloid mill or a homogenizer. The colloid mill is a device that applies a shear force to particles dispersed in a liquid to break down them into more fine-grained ones. Specific examples include a high-speed rotation mill that has a disk and stator rotating at high speed and which treats a composition while it is passed under high pressure through a narrow gap between the disk and stator, and a media-stirring pulverizer having stirring elements such as balls or beads and a vessel for storing them. The homogenizer is a device that applies a shear force to particles dispersed in a liquid to produce a homogenous, stable suspension. Specific examples include a device that vigorously stirs a composition using blades rotating at high speed to apply a shear force, and a device that feeds a composition in between a narrow gap under high pressure to apply a strong shear force.

4. Device

The composition of the present invention is preferably produced using a device comprising:

a cylinder composed of a porous membrane and a non-porous membrane, the cylinder being provided on a circumferential surface in the vicinity of one end thereof with an inlet for a continuous phase liquid and also provided in a cross section of the other end thereof with an outlet for a composition having a disperse phase finely dispersed in a continuous phase;

a disperse phase fluid storage portion provided on an outer whole periphery of the circumferential surface of the cylinder;

a jetting means for causing a disperse phase fluid from the disperse phase fluid storage portion to permeate the porous membrane and to jet into the cylinder, thereby forming a fluid column extending from a surface of the porous membrane into the cylinder; and

an introducing pipe connected to the inlet and extending approximately vertically to an axis of the cylinder and in a tangential direction to the cylinder, such that the continuous phase liquid can be caused to flow approximately vertically to the axis of the cylinder and from the tangential direction to the inner wall surface to produce a swirl flow and that, by means of a shear force of the swirl flow, a part of the fluid column can be cut off at a position with a distance of 2P to 10P) in a radial direction from the surface of the porous membrane, where P is an average pore size of the porous membrane, whereby a disperse phase particle can be produced.

(1) Cylinder

The cylinder 10 functions as a reactor. The constitutional materials, shape, size and other features of the cylinder are as described above.

(2) Introducing Pipe

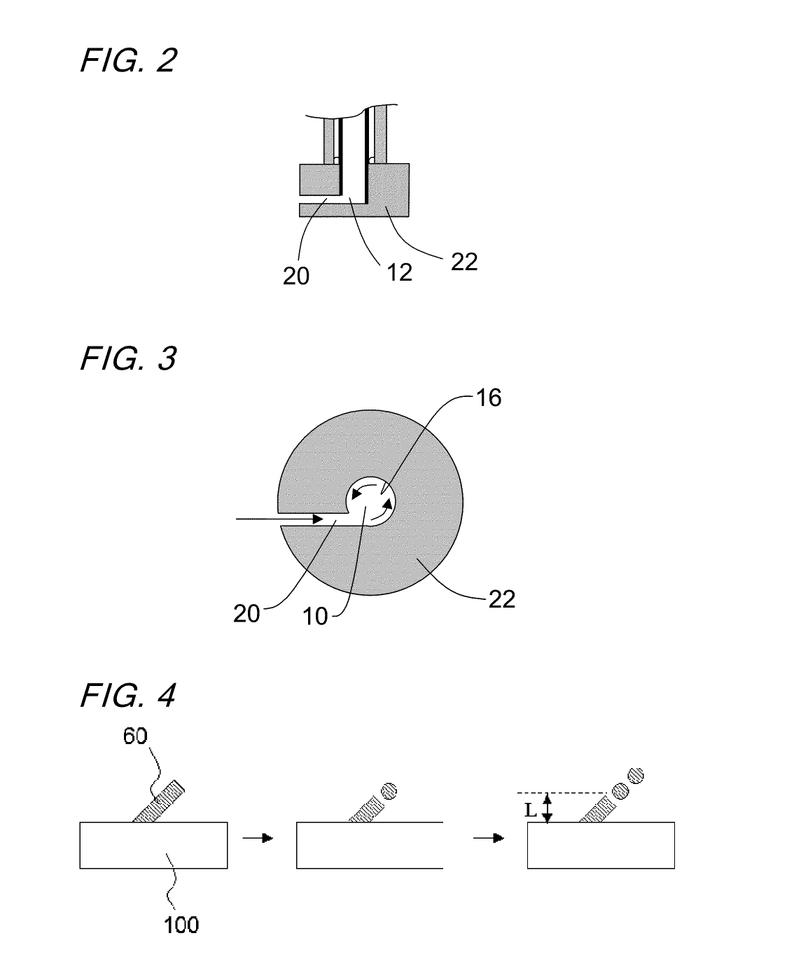

The introducing pipe 20 has a function of producing a swirl flow. As described above, the introducing pipe 20 is connected to the inlet 12 provided on the circumferential surface of the cylinder 10 and extends approximately vertically to the axis of the cylinder and in the tangential direction to the cylinder. By adjusting the thickness of the introducing pipe 20, the swirl flow velocity can be adjusted. The introducing pipe 20 is preferably formed as shown in FIGS. 1 and 2. More specifically, a thick, cylindrical member 22 having almost the same inner diameter as the cylinder 10 and having one end thereof closed is provided and is so disposed as to close an end of the cylinder 10. Then, in the member 22, a through hole is formed which extends vertically to the axis of the cylinder 10 and in a tangential direction to the cylinder 10, and this through hole serves as the introducing pipe 20. The continuous phase liquid 50 passes through the introducing pipe 20 and flows in along an inner wall of the non-porous membrane portion 101 found by the member 22 and having a circumferential surface composed of some other material than a porous membrane, so that it can produce a swirl flow effectively. The swirling velocity can be easily adjusted by varying the size of the through hole. The material of the member 22 is not particularly limited, and stainless steel is preferred from the viewpoint of the resistance to acids, alkalis, and organic solvents.

As shown in FIG. 2, the introducing pipe 20 may also be provided in the porous portion 100 of the cylinder 10. In such a case, however, that area of the porous portion 100 which is in the vicinity of the introducing pipe 20 is preferably subjected to coating treatment for preventing any leakage of the continuous phase liquid.

(3) Disperse Phase Fluid Storage Portion

As described above, the disperse phase fluid storage portion 40 preferably has a larger area than the porous membrane portion 100 of the cylinder 10. Thus, it is preferred that the member 44 should be disposed to cover the outer whole periphery of the cylinder 10 so that a space formed between an inner wall of the member 44 and an outer wall of the cylinder 10 serves as the disperse phase fluid storage portion 40. In this mode, the distance of clearance, more specifically the difference between the inner radius of the member 44 and the outer radius of the cylinder 10, is preferably in the range of 1.0 to 10 mm, and more preferably in the range of 1.5 to 4.0 mm. If this distance of clearance is smaller than 1.0 mm, increased supply rate of the disperse phase fluid may cause a pressure distribution in the storage portion 40, thereby deteriorating the uniformity in the rate of the disperse phase fluid passing through the pores of the porous membrane. On the other hand, if this clearance is larger than necessary, the amount of the disperse phase stored will increase so that the amount of the disperse phase fluid to be discarded upon disassembly or cleaning of the device will be larger, leading to waste of resource.

The material of the member 44 is not particularly limited, and stainless steel is preferred from the viewpoint of the resistance to acids, alkalis, and organic solvents. The area where the cylinder 10, the member 44, and the member 22 are connected may also have disposed therein a seal ring for preventing liquid from leaking out of the device. Exemplary seal rings include known O-rings.

(4) Jetting Means

The jetting means is not particularly limited, and a pump generating only a few pulsating flows is preferred. The jetting means is connected to the disperse phase fluid introducing pipe 42 provided on the member 44.

(5) Outlet and Discharge Pipe

The device of the present invention preferably has the outlet 14 and the discharge pipe 30 provided on the other end of the cylinder 10. The shape and size of the outlet 14 are as described above. The discharge pipe 30 connected to the outlet 14 is preferably formed by providing the cylindrical member 32 which has a desired inner diameter and includes a through hole for discharge, and by disposing said member so as to close an end of the cylinder 10. The material of the member 32 is not particularly limited, and stainless steel is preferred from the viewpoint of the resistance to acids, alkalis, and organic solvents.

### EXAMPLES

### Example 1

There was provided a cylinder (SPG Technology Co., Ltd.; SPG membrane; Lot No. PJN08I16) which measures 10 mm in outer diameter, 9 mm in inner diameter, and 150 mm in length and has a circumferential surface wholly composed of a Shirasu porous glass membrane (SPG membrane) with an average pore size of 4.9 μm. Of this SPG membrane cylinder, the two parts which respectively extend 50 mm from the upper and lower ends thereof were coated with Teflon® tape, a non-porous member, to ensure that the middle part alone of the cylinder 10 which is 50 mm in height would effectively function as a porous membrane 100. By reducing the effective part of the porous membrane in such a manner, the membrane permeation rate of the disperse phase fluid was increased to reach 48 m³/m²h. If the effective part of the porous membrane is 150 mm in height, it will then follow that the disperse phase fluid must be supplied at 3000 mL/min However, if such a large amount of disperse phase fluid is supplied to a swirl flow of a continuous phase liquid, the kinetic energy of the swirl flow will be so much consumed that the difference in kinetic energy between the upper and lower parts (areas near the inlet and outlet) of the cylinder will be increased beyond the limit. This will lead to an increase in the span of the produced disperse phase particles. Accordingly, the device comprising the porous membrane having a reduced effective area was provided with the aim of increasing the membrane permeation rate of the disperse phase while keeping the consumption of the swirling kinetic energy within the limit.

Also provided was a stainless steel cylindrical member 22 which is thicker than said SPG membrane cylinder, has the same inner diameter as said cylinder, and has one end thereof closed. As shown in FIG. 1, the member 22 was so disposed as to close an end of the SPG membrane cylinder, so that a cylindrical space measuring 5 mm in length and having a circumferential surface composed of stainless steel was formed on the end of the SPG membrane cylinder; thereupon, there was provided a cylinder 10 measuring 155 mm in total length and having both a porous portion 100 and a non-porous membrane portion 101. In the member 22, there was formed a through hole extending vertically to the axis of the cylinder 10 and in a tangential direction to the cylinder 10, and this through hole served as an introducing pipe 20. The introducing pipe had a circular cross section and an inner diameter of 2.5 mm.

A member 44 was so disposed as to cover the outer periphery of the cylinder 10, whereby a disperse phase fluid storage portion 40 was formed. The height of the disperse phase fluid storage portion 40 (the difference between the inner radius of the member 44 and the outer radius of the cylinder 10) was 2.0 mm. A stainless steel cylindrical member 32 having an outlet measuring 4.5 mm in inner diameter was disposed on the other end of the cylinder 10 so as to close said end of the cylinder 10, whereby an outlet 14 and a discharge pipe 30 were formed. As shown in FIG. 1, O-rings were inserted into the space between the member 44 and the cylinder 10, at both ends of the member 44. Thus, the production device of the present invention was provided. This production device was positioned such that, as shown in FIG. 1, the axis of the cylinder was approximately vertical and the introducing pipe 20 was located below.

An aqueous solution containing 1.0 mass % Tween 20 (Nacalai Tesque, Inc.) as a surfactant was provided as a continuous phase liquid. The continuous phase liquid was introduced through the introducing pipe 20 in a direction that is at 90 degrees to the axis of the cylinder 10 and which is tangential to the inner wall of the cylinder 10, using a gear pump at an inlet linear velocity of 12 m/s, whereby a swirl flow was produced.

Methyl laurate was provided as a disperse phase fluid, and supplied using another gear pump to the swirl flow of the continuous phase liquid through the SPG membrane having an effective area reduced to ⅓. The supply rate was varied at 500 mL/min, 700 mL/min, and 1000 mL/min. These supply velocities correspond to the membrane permeation rates of 24 m³/m²h, 32 m³/m²h, and 48 m³/m²h, respectively. Thus, the compositions of the present invention were produced in the form of 0/W emulsions.

The disperse phase particle sizes of the resulting emulsions were determined by the laser diffraction/scattering method (system name: SALD-200V; Shimadzu Corporation). Table 1 shows the characteristic values obtained at the different disperse phase supply rates, i.e., membrane permeation rates of disperse phase, intrapore linear velocities of disperse phase, spans (polydispersities), average pore sizes, volume ratios (disperse phase/continuous phase), Weber numbers, capillary numbers, and droplet formation rates. The intrapore linear velocity of disperse phase is obtained by dividing the membrane permeation rate (based on the assumption that the disperse phase fluid flows over the entire membrane surface) by the product of the SPG membrane porosity which is 0.5 and the active pore ratio which is 0.02 (this product corresponds to the volume of a pore in the porous membrane) (refer to Non-patent Document 7: Desalination, Vol. 144, 167-172 (2002)). The droplet formation rate (droplets per pore per sec) is obtained by dividing the membrane permeation rate of disperse phase by the volume of produced disperse phase particles. Additionally, the interfacial tension (γ) between disperse phase and continuous phase was set to 20 mN/m on the basis of Non-patent Document 3, and the density (ρ) of the disperse phase (methyl laurate) was set to 870 kg/m³.

### Comparative Example 1

Compositions were produced and evaluated as in Example 1, except that methyl laurate was provided as a disperse phase fluid, and the supply rate was varied at 20 mL/min, 50 mL/min, 100 mL/min, 200 mL/min, and 250 mL/min. These supply rates correspond to the membrane permeation rates of 0.92 m³/m²h, 2.3 m³/m²h, 4.6 m³/m²h, 9.2 m³/m²h, and 12 m³/m²h, respectively.

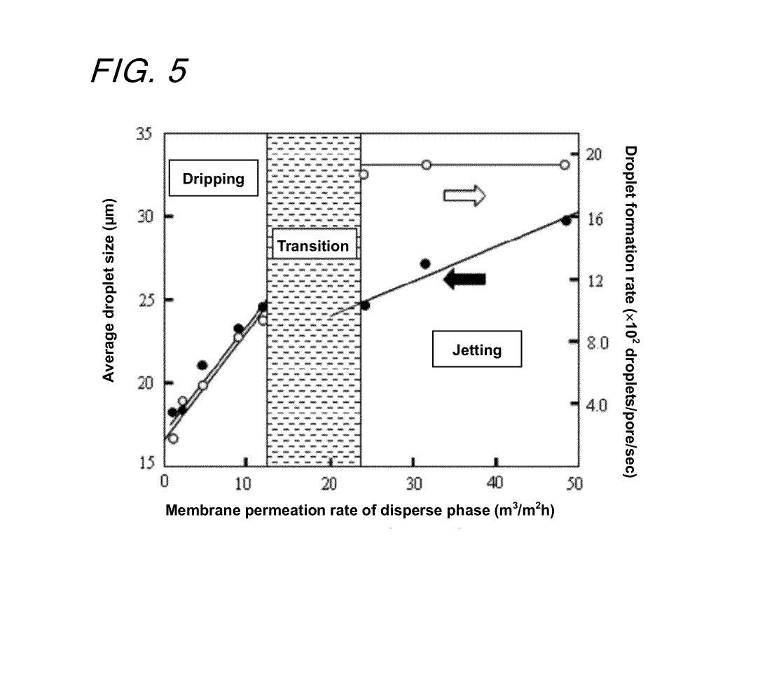

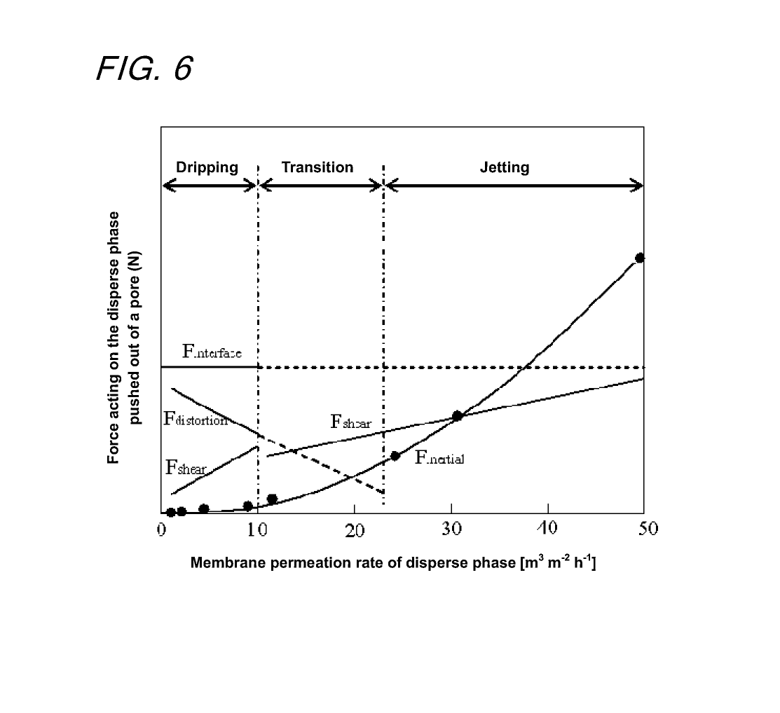

The results of Example 1 and Comparative Example 1 are collectively shown in Table 1 and FIGS. 5 and 6.

TABLE 1
Influence of the membrane permeation rate of disperse phase on swirl-flow membrane emulsification

| | | Com. Ex. 1 | | | | | Ex. 1 | | |
|---|---|---|---|---|---|---|---|---|---|
| Supply rate | mL/min | 20 | 50 | 100 | 200 | 250 | 500 | 700 | 1000 |
| Membrane | m³/m² h | 0.92 | 2.3 | 4.6 | 9.2 | 12 | 24 | 32 | 48 |
| permeation rate | | | | | | | | | |
| Intrapore linear | m/s | 0.026 | 0.064 | 0.13 | 0.26 | 0.34 | 0.67 | 0.90 | 1.3 |
| velocity | | | | | | | | | |
| Weber number | — | 5.7 × 10⁻⁴ | 3.6 × 10⁻³ | 1.4 × 10⁻² | 5.7 × 10⁻² | 9.8 × 10⁻² | 3.9 × 10⁻¹ | 7.0 × 10⁻¹ | 1.6 |
| Capillary number | — | 0.16 | 0.2 | 0.34 | 0.4 | 0.37 | 0.53 | 0.65 | 0.9 |
| Average pore size | μm | 17.8 | 18.1 | 21.4 | 24.5 | 23.4 | 24.3 | 26.9 | 29.8 |
| Span | — | 0.38 | 0.38 | 0.47 | 0.42 | 0.45 | 0.51 | 0.58 | 0.59 |
| Volume ratio | — | 0.0057 | 0.014 | 0.029 | 0.057 | 0.071 | 0.14 | 0.20 | 0.29 |
| (disperse phase/ | | | | | | | | | |
| continuous phase) | | | | | | | | | |
| Droplet | droplets/ | 0.18 × 10³ | 0.43 × 10³ | 0.52 × 10³ | 0.81 × 10³ | 0.92 × 10³ | 1.8 × 10³ | 1.9 × 10³ | 1.9 × 10³ |
| formation rate | pore/sec | | | | | | | | |

FIG. 5 is a diagram illustrating the relationship between the membrane permeation rate and particle size of disperse phase. In FIG. 5, the filled circle represents a disperse phase particle size (average droplet size), and the open circle represents a droplet formation rate defined as the quotient of the membrane permeation rate of disperse phase divided by the volume of produced disperse phase particles. As is evident from FIG. 5, there was a good linear relationship between the average droplet size and the membrane permeation rate in the region where the membrane permeation rate was not greater than 12 m³/m²h and in the region where it was not smaller than 24 m³/m²h, but these two regions were discontinuous. In the region where the membrane permeation rate was not greater than 12 m³/m²h, the droplet formation rate increased in proportion to the membrane permeation rate, and reached a maximum of 0.92×10³ droplets/pore/sec. On the other hand, in the region at not smaller than 24 m³/m²h, the droplet formation rate was unchanged (1.9×10³ droplets/pore/sec) and was much higher than that of Comparative Examples. These two regions were also discontinuous in terms of the droplet formation rate.

FIG. 6 is a diagram illustrating how the membrane permeation rate of the disperse phase related to various forces acting on a droplet in Example 1 and Comparative Example 1. In FIG. 6, F_{interface} is a force retaining the disperse phase in a pore opening of the porous membrane by means of the interfacial tension; Fᵢₙₑᵣₜᵢₐₗ (filled circle) is an inertial force generated when the disperse phase is flowed out of a pore; Fₛₕₑₐᵣ is a shear force acted on the disperse phase present on the porous membrane; and F_{distortion} is a force cutting the disperse phase, which is generated due to the deformation of a droplet. As can be seen from FIG. 6, the surface tension F_{interface} is exceeded by the inertial force Fᵢₙₑᵣₜᵢₐₗ on its own when the membrane permeation rate is approximately 37 m³/m²h. In this Example, Fₛₕₑₐᵣ does not exceed the surface tension F_{interface} and is thus considered not strong enough to independently cut the disperse phase liquid present on the porous membrane. However, the disperse phase was jetted into the continuous phase in the region at not smaller than 24 m³/m²h, where the interfacial tension F_{interface} is exceeded by the resultant force consisting of the shear force Fₛₕₑₐᵣ and the inertial force Fᵢₙₑᵣₜᵢₐₗ which acts to cause the disperse phase liquid to flow out continuously.

At a membrane permeation rate of not greater than 10 m³/m²h, the inertial force Fᵢₙₑᵣₜᵢₐₗ which is generated when the disperse phase is flowed out of a pore is considerably low. Also, the shear force Fₛₕₑₐᵣ influencing the size of the droplet to be produced is small. Under such conditions, the cutting force F_{distortion} caused by highly deformed shape of a pore increases with the growth of a droplet, whereupon the droplet is cut off. More specifically, when the resultant force consisting of the shear force Fₛₕₑₐᵣ generated by a swirl flow and the cutting force F_{distortion} generated by a droplet itself due to its deformation exceeds the interfacial tension F_{interface} retaining the droplet on a porous membrane, detachment of the droplet takes place. It is considered that the cutting force F_{distortion} decreases with the increase in the outlet velocity of the disperse phase from a pore, and that when a disperse phase droplet starts to depart from the porous membrane, the force by which the droplet can cut itself on the neck decreases rapidly. This is a transition state (at a membrane permeation rate ranging from 12 to 24 m³/m²h).

### Example 2

A low viscosity-type liquid paraffin (product name: Paraffin Liquid, Low Viscosity Type; Nacalai Tesque, Inc.) was provided as a disperse phase liquid, and an aqueous solution containing 1.0 mass % of a surfactant (product name: Tween 20; Nacalai Tesque, Inc.) was provided as a continuous phase liquid. With these two liquids being warmed at 70° C., emulsions were produced using the device produced in Example 1. In the process, the output of a pump was adjusted to produce emulsions using all combinations of the inlet linear velocity of continuous phase (i.e., 6.8 m/s, 8.5 m/s, 10.2 m/s, 11.2 m/s, and 13.6 m/s) and the membrane permeation rate of disperse phase (i.e., 24 m³/m²h, 32 m³/m²h, and 48 m³/m²h) and the produced emulsions were then evaluated.

### Comparative Example 2

An emulsion was produced and evaluated as in Example 1, except that the membrane permeation rate of the disperse phase was set to 2.3 m³/m²h.

The results of Example 2 and Comparative Example 2 are shown in Tables 2 and 3.

TABLE 2
Average droplet size of disperse phase particles (μm)

| | |
|---|---|
| Com. Ex. 2 | Ex. 2 |

Membrane permeation rate of
disperse phase (m³/m²h)

| Average pore size 4.9 μm | | 2.3 | 24 | 32 | 48 |
|---|---|---|---|---|---|
| Inlet linear | 6.8 | 20.9 | 42.6 | 43.9 | 56.0 |
| velocity of | 8.5 | 19.7 | 35.1 | 33.9 | 48.0 |
| continuous | 10.2 | 19.4 | 30.1 | 21.7 | 38.7 |
| phase (m/s) | 11.2 | 18.3 | 26.2 | 19.2 | 26.0 |
| | 13.6 | 18.6 | 24.1 | 18.2 | 26.0 |

TABLE 3
Span of disperse phase particles

| | |
|---|---|
| Com. Ex. 2 | Ex. 2 |

Membrane permeation rate of
disperse phase (m³/m²h)

| Average pore size 4.9 μm | | 2.3 | 24 | 32 | 48 |
|---|---|---|---|---|---|
| Inlet linear | 6.8 | 0.45 | 0.66 | 0.92 | 0.68 |
| velocity of | 8.5 | 0.46 | 0.70 | 0.97 | 0.72 |
| continuous | 10.2 | 0.45 | 0.55 | 0.42 | 0.87 |
| phase (m/s) | 11.2 | 0.38 | 0.50 | 0.42 | 1.10 |
| | 13.6 | 0.37 | 0.45 | 0.38 | 0.62 |

At the membrane permeation rate of 2.3 m³/m²h (Comparative Example 2), the disperse phase pushed out of pores formed droplet particles on the porous membrane, individual particles were dripped off from the membrane surface. On the other hand, at the membrane permeation rates of 24, 32 and 48 m³/m²h (Example 2), the inertial force generated when the disperse phase is pushed out of a pore exceeds the surface tension retaining the disperse phase on the membrane surface; thus, the disperse phase was continuously jetted from the pores to form liquid columns, and the liquid columns were cut at a position with a specified distance from the porous membrane to form disperse phase particles. At the membrane permeation rate of 2.3 m³/m²h (Comparative Example 2), the span was below 0.4 when the continuous phase was supplied at the inlet linear velocities of 11.2 and 13.6 m/s. Also, at the membrane permeation rate of 32 m³/m²h (Example 2), the span was 0.38 when the continuous phase was supplied at the inlet linear velocity of 13.6 in/s. Therefore, the present invention can produce an emulsion with low polydispersity even at an increased membrane permeation rate.

### Example 3

Emulsions were produced and evaluated under the same conditions as in Example 2 except using a SPG membrane with an average pore size of 10.1 μm (SPG Technology Co., Ltd.; SPG membrane; Lot No. PJN08J17).

### Comparative Example 3

An emulsion was produced and evaluated under the same conditions as in Comparative Example 2 except using a SPG membrane with an average pore size of 10.1 μm (SPG Technology Co., Ltd.; SPG membrane; Lot No. PJN08J17).

The results of Example 3 and Comparative Example 3 are shown in Tables 4 and 5.

TABLE 4
Average droplet size of disperse phase particles (μm)

| | | Com. Ex. 3 | | Example 3 | |
|---|---|---|---|---|---|
| | | Membrane permeation rate of | | | |
| | | disperse phase (m³/m²h) | | | |
| Average pore size 10.1 μm | | 2.3 | 24 | 32 | 48 |
| Inlet linear | 6.8 | 37.1 | 44.2 | 58.2 | 78.2 |
| velocity of | 8.5 | 35.8 | 42.9 | 45.7 | 60.5 |
| continuous | 10.2 | 33.1 | 39.8 | 47.9 | 53.7 |
| phase (m/s) | 11.2 | 30.4 | 36.2 | 42.5 | 49.4 |
| | 13.6 | 26.9 | 33.6 | 34.6 | 43.2 |

TABLE 5
Span of disperse phase particles

| | | Com. Ex. 3 | | Example 3 | |
|---|---|---|---|---|---|
| | | Membrane permeation rate of | | | |
| | | disperse phase (m³/m²h) | | | |
| Average pore size 10.1 μm | | 2.3 | 24 | 32 | 48 |
| Inlet linear | 6.8 | 0.41 | 0.56 | 0.62 | 1.02 |
| velocity of | 8.5 | 0.44 | 0.53 | 0.62 | 0.71 |
| continuous | 10.2 | 0.48 | 0.64 | 0.54 | 0.75 |
| phase (m/s) | 11.2 | 0.41 | 0.47 | 0.62 | 0.67 |
| | 13.6 | 0.50 | 0.54 | 0.71 | 0.65 |

Also in the examples concerned, the formation of disperse phase particles had the same behavior as in Example 2 and Comparative Example 2. At the membrane permeation rate of 2.3 m³/m²h (Comparative Example 3), the span was 0.41 when the continuous phase was supplied at the inlet linear velocities of 6.8 and 11.2 m/s. Also, at the membrane permeation rate of 24 m³/m²h (Example 3), in which the disperse phase fluid is jetted, the span was a minimum of 0.47 when the continuous phase was supplied at the inlet linear velocity of 11.2 m/s. Therefore, the present invention can produce an emulsion with low polydispersity even at an increased membrane permeation rate.

### Example 4

Emulsions were produced and evaluated under the same conditions as in Example 2 except using a SPG membrane with an average pore size of 19.9 μm (SPG Technology Co., Ltd.; SPG membrane; Lot No. PJN08E01).

### Comparative Example 4

An emulsion was produced and evaluated under the same conditions as in Comparative Example 2 except using a SPG membrane with an average pore size of 19.9 μm (SPG Technology Co., Ltd.; SPG membrane; Lot No. PJN08E01).

The results of Example 4 and Comparative Example 4 are shown in Tables 6 and 7.

TABLE 6
Average droplet size of disperse phase particles (μm)

| | | Com. Ex. 4 | | Example 4 | |
|---|---|---|---|---|---|
| | | Membrane permeation rate of | | | |
| | | disperse phase (m³/m²h) | | | |
| Average pore size 19.9 μm | | 2.3 | 24 | 32 | 48 |
| Inlet linear | 6.8 | 60.9 | 70.3 | 62.2 | 62.0 |
| velocity of | 8.5 | 56.0 | 65.2 | 61.1 | 56.6 |
| continuous | 10.2 | 53.6 | 64.1 | 64.3 | 50.5 |
| phase (m/s) | 11.2 | 44.1 | 52.9 | 62.1 | 47.5 |
| | 13.6 | 43.1 | 50.2 | 59.7 | 38.0 |

TABLE 7
Span of disperse phase particles

| | | Com. Ex. 4 | | Example 4 | |
|---|---|---|---|---|---|
| | | Membrane permeation rate of | | | |
| | | disperse phase (m³/m²h) | | | |
| Average pore size 19.9 μm | | 2.3 | 24 | 32 | 48 |
| Inlet linear | 6.8 | 0.45 | 0.59 | 0.68 | 0.44 |
| velocity of | 8.5 | 0.50 | 0.56 | 1.12 | 0.47 |
| continuous | 10.2 | 0.49 | 0.68 | 0.73 | 0.58 |
| phase (m/s) | 11.2 | 0.62 | 0.79 | 0.87 | 0.67 |
| | 13.6 | 0.72 | 0.64 | 0.60 | 0.76 |

Also in the examples concerned, the formation of disperse phase particles had the same behavior as in Example 2 and Comparative Example 2. At the membrane permeation rate of 2.3 m³/m²h (Comparative Example 4), the span was 0.45 when the continuous phase was supplied at the inlet linear velocity of 6.8 m/s. Also, at the membrane permeation rate of 48 m³/m²h (Example 4), the span was 0.44 when the continuous phase was supplied at the inlet linear velocity of 6.8 m/s.

The Examples given on the foregoing pages show that the present invention can produce emulsions with low polydispersities, even using porous membranes with different pore sizes and at increased membrane permeation rates.

### Example 5

A device was produced as in Example 1 except using a cylinder (SPG Technology Co., Ltd.; SPG membrane; Lot No. JPU08E01) which measures 10 mm in outer diameter, 9 mm in inner diameter, and 150 mm in length and has a circumferential surface wholly composed of a hydrophobically treated Shirasu porous glass membrane (SPG membrane) with an average pore size of 10 μm.

Kerosene containing 1.0 mass % of the surfactant sorbitan monostearate (product name: SPAN60; Tokyo Chemical Industry Co., Ltd.) was provided as a continuous phase liquid. The continuous phase liquid was introduced through the introducing pipe 20 in a direction that is at 90 degrees to the axis of the cylinder 10 and which is tangential to the inner wall of the cylinder 10, using a gear pump at an inlet linear velocity of 6.8 m/s, whereby a swirl flow was produced.

Deionized water was provided as a disperse phase fluid, and supplied through the porous membrane to the swirl flow of the continuous phase liquid using another gear pump. The supply rate was varied at 500 mL/min, 700 mL/min, and 1000 mL/min. Thus, the compositions of the present invention were produced in the form of W/O emulsions. The disperse phase particle sizes of the resulting emulsions were determined by the laser diffraction/scattering method (system name: SALD-200V; Shimadzu Corporation). The results are shown in FIG. 8.

### Comparative Example 5

W/O emulsions were produced and evaluated as in Example 5, except that the supply rate was varied at 20 mL/min, 50 mL/min, 100 mL/min, 200 mL/min, and 250 mL/min. The results are shown in FIG. 8.

TABLE 8
Production of W/O emulsions through the hydrophobic SPG membrane

| | | Com. Ex. 5 | | | | | Ex. 5 | | |
|---|---|---|---|---|---|---|---|---|---|
| Supply rate | mL/min | 20 | 50 | 100 | 200 | 250 | 500 | 700 | 1000 |
| Membrane permeation | m³/m² h | 0.92 | 2.3 | 4.6 | 9.2 | 12 | 24 | 32 | 48 |
| rate | | | | | | | | | |
| Intrapore linear velocity | m/s | 0.026 | 0.064 | 0.13 | 0.26 | 0.34 | 0.67 | 0.90 | 1.3 |
| Average pore size | μm | 40.2 | 39.4 | 44.9 | 47.5 | 45.3 | 46.3 | 42.8 | 51.4 |
| Span | — | 0.36 | 0.49 | 0.49 | 0.52 | 0.56 | 0.60 | 0.63 | 0.66 |
| Volume ratio | — | 0.01 | 0.025 | 0.05 | 0.10 | 0.125 | 0.25 | 0.35 | 0.50 |
| (disperse phase/ | | | | | | | | | |
| continuous phase) | | | | | | | | | |

Continuous phase: Kerosene at an inlet linear velocity of 6.8 (m/s)
Disperse phase: Water

Table 8 shows that the present invention can produce a W/O emulsion with low polydispersity even at an increased membrane permeation rate.

### Example 6

A 0.5 mass % surfactant (product name: Span 80, Nacalai Tesque, Inc.) was added to the low viscosity-type liquid paraffin used in Example 2 to give a disperse phase liquid. Deionized water was provided as a continuous phase liquid. With the disperse phase liquid being warmed at 70° C., emulsions were produced under the following conditions using the device produced in Example 1. The results are shown in FIGS. 9 and 10.

SPG membranes used: SPG membranes with average pore sizes of 2.1 μm, 4.9 μM, 10.1 μm (SPG Technology Co., Ltd.; SPG membranes; Lot Nos. PJN09C03, PJN08I16 and PJN08J17).

Inlet linear velocity of continuous phase: 13.6 m/s.

Membrane permeation rates of disperse phase: 24 m³/m²h, 32 m³/m²h, and 48 m³/m²h.

### Comparative Example 6

An emulsion was produced and evaluated as in Example 6, except that the membrane permeation rate of disperse phase was set to 2.3 m³/m²h. The results are shown in FIGS. 9 and 10.

TABLE 9
Average droplet size of disperse phase particles (μm)

| | |
|---|---|
| Com. Ex. 6 | Ex. 6 |

| | |
|---|---|
| | Membrane permeation rate of |
| Average pore size | disperse phase (m³/m²h) |

| (μm) | 2.3 | 24 | 32 | 48 |
|---|---|---|---|---|
| 2.0 | 12.8 | 11.6 | 10.9 | 18.9 |
| 4.9 | 21.6 | 28.4 | 33.0 | 34.0 |
| 10.1 | 41.0 | 53.9 | 52.7 | 42.0 |

TABLE 10
Span of disperse phase particles

| | |
|---|---|
| Com. Ex. 6 | Ex. 6 |

| | |
|---|---|
| | Membrane permeation rate of |
| Average pore size | disperse phase (m³/m²h) |

| (μm) | 2.3 | 24 | 32 | 48 |
|---|---|---|---|---|
| 2.0 | 0.53 | 0.57 | 0.55 | 0.66 |
| 4.9 | 0.47 | 0.63 | 0.60 | 0.76 |
| 10.1 | 0.67 | 0.59 | 0.60 | 0.62 |

The results show that even when a surfactant is added to the disperse phase liquid, the present invention can produce an emulsion with low polydispersity at a high membrane permeation rate.

### Example 7

As a preliminary composition, there was provided the O/W emulsion that was produced in Example 1 using the disperse phase at a membrane permeation rate of 32 m³/m²h and which has an average droplet size of 26.9 μm, a span of 0.58, and a volume ratio (disperse phase/continuous phase) of 0.20. A device was produced as in Example 1 except using a SPG membrane with an average pore size of 1.0 μm (SPG Technology Co., Ltd.; SPG membrane; Lot No. PJN07J06). The preliminary composition was injected from an opening of a disperse phase fluid introducing pipe 42 into a disperse phase fluid storage portion 40 using a gear pump and caused to pass through a porous membrane 100 at a membrane permeation rate of 2.2 m³/m²h, whereby a fine-grained composition was produced. No continuous phase liquid was supplied to the cylinder. The resulting fine-grained composition was continuously recovered from an upper opening 30.

### Comparative Example 7

There was provided 500 mL of an aqueous solution containing deionized water and a 1.0 mass % surfactant (product name: Tween 20; Nacalai Tesque, Inc.). 100 mL of methyl laurate was added to the solution, and the mixture was stirred at 3000 rpm for 15 minutes using a homomixer (AHG-160D; AS ONE Corporation), whereby a preliminary composition for comparison was produced. Then, a fine-grained composition for comparison was produced as in Example 7 using the preliminary composition for comparison. The results are shown in Table 11.

TABLE 11
Fine-grained composition

| | | | Droplet size |
|---|---|---|---|
| | | Average droplet | distribution |
| | | size (μm) | (span) |
| Ex. 7 | Preliminary composition | 39.5 | 0.43 |
| | Fine-grained composition | 1.7 | 0.51 |
| Com. Ex. 7 | Preliminary composition | 39.0 | 1.77 |
| | for comparison | | |
| | Fine-grained composition | 2.1 | 1.20 |
| | for comparison | | |

It is shown that when the O/W emulsion of the present invention was used as a preliminary composition, a fine-grained composition with low monodispersity and a smaller disperse phase particle size can be obtained.

### REFERENCE SIGNS LIST

1 Production device of the present invention
10 Cylinder
100 Porous membrane portion having a circumferential surface composed of a porous membrane; or porous membrane
101 Non-porous membrane portion having a circumferential surface composed of some other material
102 Non-porous membrane member
12 Inlet
14 Outlet
16 Inner wall surface
20 Introducing pipe
22 Member
30 Discharge pipe
32 Member
40 Disperse phase fluid storage portion
42 Disperse phase fluid introducing pipe
44 Member
60 Disperse phase fluid
80 Seal ring

1. A method for producing a composition having a disperse phase finely dispersed in a continuous phase, the method comprising the steps of:
(A) supplying a swirl flow of a continuous phase liquid into a cylinder having a circumferential surface partially or wholly composed of a porous membrane;
(B1) jetting a disperse phase fluid through the porous membrane into the swirl flow to form a fluid column extending from a surface of the porous membrane into the cylinder; and
(B2) by means of a shear force of the swirl flow, cutting off a part of the fluid column at a position with a distance of 2P to 10P in a radial direction from the surface of the porous membrane, where P is an average pore size of the porous membrane.

2. The method according to claim 1, wherein the resultant composition has a span of 0.2-1.5, the span being defined by the following equation (1):
Span=(d₉₀−d₁₀)/d₅₀ (1)
where:
d₁₀: the particle size at 10% in the cumulative distribution of disperse phase particles,
d₉₀: the particle size at 90% in the cumulative distribution of disperse phase particles,
d₅₀: the particle size at 50% in the cumulative distribution of disperse phase particles.

3. The method according to claim 1,
wherein the cylinder is provided on the circumferential surface in the vicinity of one end thereof with an inlet for the continuous phase liquid and also provided with an introducing pipe extending from the inlet approximately vertically to the axis of the cylinder and in a tangential direction to the cylinder, and
wherein the step (A) is a step at which the continuous phase liquid is caused to flow through the introducing pipe approximately vertically to the axis of the cylinder and from the tangential direction to an inner wall surface of the cylinder to thereby produce a swirl flow.

4. The method according to claim 1, wherein the disperse phase fluid contains a surfactant.

5. A method for producing a composition, comprising the steps of:
(C) providing a preliminary composition produced by the method according to claim 1; and
(D) applying a shear force to the preliminary composition to obtain a composition having, finely dispersed in a continuous phase, a disperse phase with a smaller average particle size than the disperse phase of the preliminary composition.

6. The method according to claim 5, wherein at the step (D), the shear force is applied to the preliminary composition by passing the preliminary composition through a porous membrane.

7. The method according to claim 5, wherein at the step (D), the shear force is applied to the preliminary composition by treating the preliminary composition using a colloid mill or a homogenizer.

8. A production device for a method for producing a composition having a disperse phase finely dispersed in a continuous phase, the production device comprising:
a cylinder composed of a porous membrane and a non-porous membrane, the cylinder being provided on a circumferential surface in the vicinity of one end thereof with an inlet for a continuous phase liquid and also provided in a cross section of the other end thereof with an outlet for the composition having the disperse phase finely dispersed in the continuous phase;
a disperse phase fluid storage portion provided on an outer whole periphery of the circumferential surface of the cylinder;
a jetting means for causing the disperse phase fluid from the disperse phase fluid storage portion to permeate the porous membrane and to jet into the cylinder, thereby forming a fluid column extending from a surface of the porous membrane into the cylinder; and
an introducing pipe connected to the inlet and extending approximately vertically to an axis of the cylinder and in a tangential direction to the cylinder, such that the continuous phase liquid can be caused to flow approximately vertically to the axis of the cylinder and from the tangential direction to the inner wall surface to produce a swirl flow and that, by means of a shear force of the swirl flow, a part of the fluid column can be cut off at a position with a distance of 2P to 10P in a radial direction from the surface of the porous membrane, where P is an average pore size of the porous membrane, whereby a disperse phase particle can be produced.

9. The method according to claim 2,
wherein the cylinder is provided on the circumferential surface in the vicinity of one end thereof with an inlet for the continuous phase liquid and also provided with an introducing pipe extending from the inlet approximately vertically to the axis of the cylinder and in a tangential direction to the cylinder, and
wherein the step (A) is a step at which the continuous phase liquid is caused to flow through the introducing pipe approximately vertically to the axis of the cylinder and from the tangential direction to an inner wall surface of the cylinder to thereby produce a swirl flow.

10. The method according to claim 2, wherein the disperse phase fluid contains a surfactant.

11. The method according to claim 3, wherein the disperse phase fluid contains a surfactant.

12. A method for producing a composition, comprising the steps of:
(C) providing a preliminary composition produced by the method according to claim 2; and
(D) applying a shear force to the preliminary composition to obtain a composition having, finely dispersed in a continuous phase, a disperse phase with a smaller average particle size than the disperse phase of the preliminary composition.

13. A method for producing a composition, comprising the steps of:
(C) providing a preliminary composition produced by the method according to claim 3; and
(D) applying a shear force to the preliminary composition to obtain a composition having, finely dispersed in a continuous phase, a disperse phase with a smaller average particle size than the disperse phase of the preliminary composition.

14. A method for producing a composition, comprising the steps of:
(C) providing a preliminary composition produced by the method according to claim 4; and
(D) applying a shear force to the preliminary composition to obtain a composition having, finely dispersed in a continuous phase, a disperse phase with a smaller average particle size than the disperse phase of the preliminary composition.
